(19) United States
(12) Patent Application Publication
(10) Pub. No.: US 2020/0063492 A1
(43) Pub. Date: Feb. 27, 2020

(54) LADDER STABILIZATION DEVICE

(71) Applicant: David Wesley McCormick, Youngstown, OH (US)

(72) Inventor: David Wesley McCormick, Youngstown, OH (US)

(21) Appl. No.: 16/106,965

(22) Filed: Aug. 21, 2018

(51) Int. Cl. E06C 7/10

(52) U.S. Cl. CPC E06C 7/10

(57) ABSTRACT

An embodiment provides a method including: attaching a ladder connector portion of a ladder stabilization device to a beam of a ladder, comprising wrapping a ladder tether portion of the ladder connector portion around the beam of the ladder to create at least one loop around the beam and connecting a ladder quick disconnect mechanism to a ladder holding mechanism located within the ladder connector portion; attaching an object connector portion of the ladder stabilization device to a portion of the object, comprising securing an object tether portion of the object connector portion to the portion of the object using an object quick disconnect mechanism; and adjusting a length of the ladder stabilization device to a length to remove slack of the ladder stabilization device between the beam and the portion of the object using an adjustment mechanism.

### BACKGROUND

Many jobs require ladders in order to reach the intended location, for example, to reach a roof, reach branches in a tree, reach a ceiling, and the like. The ladder may be used to merely allow the person to be higher so that they can reach a certain location, for example, using a ladder to paint a ceiling. Alternatively, the ladder may be used so that a person can access a higher location, for example, the ladder is a conveyance mechanism that is used to allow a person to access a roof, a higher story in a building, branches in a tree, or the like. In other words, a ladder may either be used as a platform where a person stands to perform a task or as a conveyance mechanism used to reach a new higher location. Many types of ladders exist, each having advantages and disadvantages over other types of ladders. For example, an A-frame ladder allows for a more stable working platform due to the use of two leg portions of the frame. However, these ladders are only so tall and may be unstable over uneven terrain. An extension ladder allows for access to higher locations than an A-frame ladder, but, since the extension ladder only has a single leg portion, it may not be as stable, particularly in a side-to-side direction as the A-frame ladder.

Typically the application that the ladder is being used in will dictate the type of ladder that is used. For example, generally extension ladders are used as conveyance devices to access higher locations due to the ability to extend the ladder further than what is possible using an A-frame ladder. On the other hand, A-frame ladders are typically used for platform tasks, for example, when a person is using the ladder to paint a ceiling.

### BRIEF SUMMARY

One embodiment provides a method for stabilizing a ladder with respect to an object, comprising: attaching a ladder connector portion of a ladder stabilization device to a beam of a ladder, the beam being a portion of the ladder proximate to a location of an object; the attaching a ladder connector portion comprising wrapping a ladder tether portion of the ladder connector portion around the beam of the ladder to create at least one loop around the beam and connecting a ladder quick disconnect mechanism located at substantially the end of the ladder tether portion to a ladder holding mechanism located within the ladder connector portion to retain the at least one loop of the ladder tether portion around the beam; attaching an object connector portion of the ladder stabilization device to a portion of the object, the portion of the object being proximate to the beam of the ladder; the attaching an object connector portion comprising securing an object tether portion of the object connector portion to the portion of the object using an object quick disconnect mechanism located at substantially the end of the object tether portion; and adjusting a length of the ladder stabilization device to a length to remove slack of the ladder stabilization device between the beam and the portion of the object using an adjustment mechanism, the adjustment mechanism being located within the ladder stabilization device between the ladder connector portion and the object connector portion.

Another embodiment provides a system for stabilizing a ladder with respect to an object, comprising: two ladder stabilization devices, each ladder stabilization device comprising: a ladder connector portion comprising: a ladder tether portion, a ladder quick disconnect mechanism located at substantially the end of the ladder tether portion, and a ladder holding mechanism for connection of the ladder quick disconnect mechanism; wherein, when in use, the ladder tether portion is wrapped around a beam of a ladder to create at least one loop around the beam, the beam being proximate to an object, and the ladder quick disconnect mechanism is connected to the ladder holding mechanism to retain the at least one loop of the ladder tether portion around the beam; an object connector portion comprising: an object tether portion and an object quick disconnect mechanism located at substantially the end of the object tether portion; wherein, when in use, the object quick disconnect mechanism is used to secure the object tether portion to a portion of the object, the portion of the object being proximate to the beam of the ladder; and an adjustment mechanism located between the ladder connector portion and the object connector portion, wherein the adjustment mechanism comprises a mechanism for adjusting a length of at least one of: the ladder tether portion and the object tether portion.

Another embodiment provides a system for stabilizing a ladder with respect to an object, comprising: two ladder stabilization devices, each ladder stabilization device comprising: a ladder connector portion comprising: a ladder tether portion comprising paracord, a ladder quick disconnect mechanism comprising a carabiner and located at the end of the ladder tether portion, and a ladder holding mechanism comprising a ring for connection of the ladder quick disconnect mechanism; wherein, when in use, the ladder tether portion is wrapped around a beam of a ladder to create at least one loop around the beam, the beam being proximate to an object, and the ladder quick disconnect mechanism is connected to the ladder holding mechanism to retain the at least one loop of the ladder tether portion around the beam; an object connector portion comprising: an object tether portion comprising braided webbing, an object quick disconnect mechanism comprising a carabiner and located at the end of the object tether portion; wherein, when in use, the object tether portion is wrapped around a portion of the object to create at least one loop around the portion of the object, the portion of the object being proximate to the beam of the ladder, and the quick disconnect mechanism is connected to an object holding mechanism comprising a ring to retain the at least one loop of the object tether portion around the portion of the object; and an adjustment mechanism located between the ladder connector portion and the object connector portion, wherein the adjustment mechanism comprises a rope adjustment mechanism for adjusting a length of at least one of: the ladder tether portion and the object tether portion to remove slack of the ladder stabilization device between the beam and the portion of the object.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example method of stabilizing a ladder with respect to an object.

FIG. 2 illustrates an illustrative example of a ladder stabilization system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A common problem with ladders, no matter the type, is that the ladder may be unstable in certain conditions. For example, when an A-frame ladder is used on uneven terrain, the stability of the ladder may be suspect. When a person then climbs the ladder, the ladder may wobble and may possibly fall causing injury to the person. An extension ladder, or other type of ladder that only has a single frame leg, may be particularly unstable due to the fact that the ladder only has two feet to assist in stabilizing the ladder. Additionally, since these types of ladders only have a single frame leg, these ladders are positioned such that they are leaning against an object (e.g., house, tree, gutters, shed, etc.). Thus, if the ladder is not positioned correctly, the ladder may tilt to one side or another causing it to slide laterally along the surface of the object, or may then fall down, which may injure the person climbing the ladder, damage the object, or may leave the person stranded at the higher elevation with no safe, controlled way to descend to the ground.

In order to reduce some ladder injuries, devices have been developed to tether a person to the ladder. Some of these devices includes harnesses, belts, or the like, that include a tether that goes from the harness or belt and attach either to a rung or a beam of the ladder. These devices may help prevent the person from falling off the ladder or at least falling to the ground from the ladder. For example, while wearing this device if a person overreaches while on the ladder and loses their balance, when they fall, they will be caught by the device and be prevented from falling to the ground, thereby reducing injuries or death. However, these devices do not prevent the ladder from falling. Thus, if the person is tethered to the ladder and the ladder falls, the person will end up falling with the ladder. Instead of attaching to the ladder, some devices attach to the object itself. Thus, the person is tethered to the object instead of the ladder. Then, if the ladder falls, the person will not be taken down with the ladder and will instead hang from the object itself. However, these devices still do not prevent the ladder from falling. Rather, these devices seek to reduce the injuries to people by tethering them to the object, rather than a possible falling ladder.

Accordingly, an embodiment provides a method for stabilizing a ladder with respect to an object by providing a ladder stabilization device. Such a device provides a mechanism for stabilizing the ladder to assist in preventing the ladder from falling when positioned against or proximate to an object. Thus, the ladder stabilization device decreases ladder related injuries and damage to objects caused by ladders falling. Additionally, when a ladder falls and strands a person at a higher elevation, the people may call emergency services for assistance in descending to the lower elevation. In this instance, the ladder stabilization device reduces the number of stranded person calls, thereby reducing the burden on emergency services summoned to assist the stranded person.

The ladder stabilization system provides mechanisms for tethering the ladder to the object that the ladder is proximate to. The system includes a ladder connector portion that has a tether, a quick disconnect mechanism, and a holding mechanism. The tether is wrapped around a beam of the ladder and the quick disconnect mechanism is attached to the holding mechanism to create a portion that is attached to the ladder. The system also includes an object connector portion that includes a tether and quick disconnect mechanism that allow for tethering to a portion of the object. The two connector portions are connected by an adjustment mechanism that allows for reducing the length of the ladder stabilization device so that the slack may be taken out, thereby reducing the amount of movement that is possible by the ladder.

The illustrated example embodiments will be best understood by reference to the figures. The following description is intended only by way of example, and simply illustrates certain example embodiments.

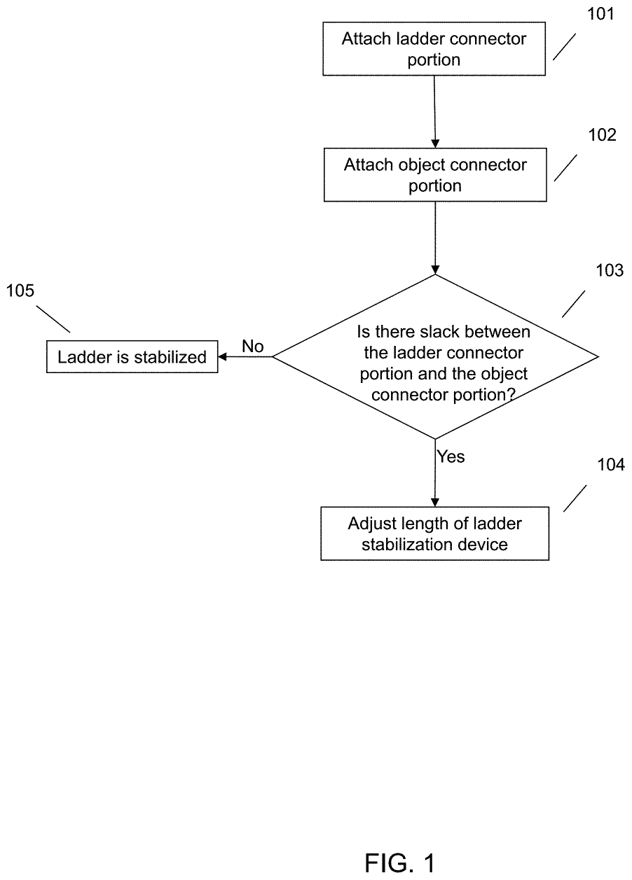

FIG. 1 illustrates a method for stabilizing a ladder with respect to an object using a ladder stabilization device. The ladder may be positioned next to, touching, or otherwise proximate to an object (e.g., house, shed, tree, wall, building, etc.). For example, in the case of an extension ladder, the ladder may be leaning against the object. As another example, in the case of an A-frame ladder, the ladder may be sitting next to the object. At 101 a ladder connector portion of the ladder stabilization device may be attached to a beam of the ladder. A beam is the portion of a ladder that is perpendicular to the rungs. Each of the rungs connects between two beams of the ladder, one beam being located at each side of the rungs. The rungs are the portion of the ladder that are used by a person to climb the ladder. In other words, the rungs are the steps of the ladder.

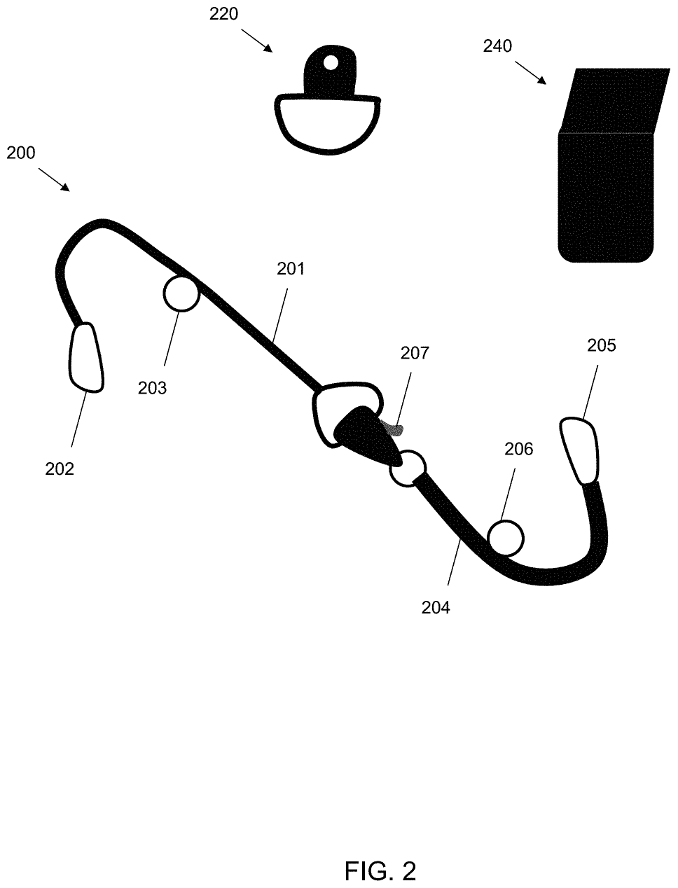

The ladder connector portion may be placed at a working height location on one or both beams between or at rungs of the ladder. A working height location is considered the location of the ladder that is either touching the object or at the location where the person will be working or dismounting the ladder and is usually towards the top of the ladder, but could be at any location on the ladder. Thus, the beam may be a portion of the ladder proximate to a location of the object (e.g., the location where the ladder is touching or closest to the object, etc.). Referring to FIG. 2 for an illustration, the ladder connector portion of the ladder stabilization device 200 may include a ladder tether portion 201, ladder quick disconnect mechanism 202, and a ladder holding mechanism 203. The illustration of FIG. 2 is merely an illustration of an example embodiment and is not meant to be limiting. Other quick disconnect mechanisms may be used, as discussed in more detail below, other tethering materials may be used, as discussed in more detail below, the configuration of the components may be different, as discussed in more detail below, and the like.

The ladder tether portion 201 may be any of a variety of different materials, for example, paracord, braided webbing, wire, rope, a composite tether, or any other suitable tethering material. The illustration of FIG. 2 illustrates a quick disconnect mechanism 202 comprising a carabiner. However, other quick disconnect mechanisms may be used, for example, buckles, hooks, snaps, shackles, devises, or any other suitable quick disconnect mechanism. Additionally, a mechanism that does not allow for a quick disconnect may be used. However, the use of a non-quick disconnect would cause the time for installation of the ladder stabilization device to increase. The ladder holding mechanism 203 may be a variety of different mechanisms, for example, a ring as shown in FIG. 2, a loop of the tether portion 201, a hook, a buckle, a snap, or any other suitable holding mechanism.

The quick disconnect mechanism 202 and the holding mechanism 203 may be complementary pieces of a single coupling mechanism. For example, the quick disconnect mechanism 202 may be one portion of a buckle and the holding mechanism 203 may be the complementary portion of the buckle. Additionally, the quick disconnect mechanism 202 and the holding mechanism 203 may be selected so that they will work together. For example, if a carabiner is selected for the quick disconnect mechanism 202, the holding mechanism 203 may be a component that will interface with the carabiner. For example, selecting a buckle for the holding mechanism 203 when the quick disconnect mechanism 202 is a carabiner would not be a good selection since the carabiner could not interface or connect to the buckle.

FIG. 2 illustrates the quick disconnect mechanism 202 at substantially the end of the ladder tether 201. However, the quick disconnect mechanism 202 may be located at a different location with respect to the ladder tether 201. The quick disconnect mechanism 202 may be attached to the ladder tether 201 using a variety of techniques. For example, the ladder tether 202 may be wrapped around the quick disconnect mechanism 202 and tied, mechanically attached, or otherwise attached to the quick disconnect mechanism 202. As another example, the quick disconnect mechanism 202 may be an integral portion of the ladder tether 201, for example, by being manufactured together, by being inserted into the ladder tether 201, or the like. Other attachment techniques may be used for attaching the quick disconnect mechanism 202 to the ladder tether 201. Similarly, the ladder holding mechanism 203 may be attached to the ladder tether 201 using a variety of attachment techniques. Additionally, the ladder holding mechanism 203 may be located at different locations with respect to the ladder tether 201, other than that as shown in FIG. 2.

The ladder connector portion is attached to the ladder beam, or both ladder beams, by wrapping or looping the ladder tether 201 around the beam or beams to create one or more loops around the ladder beam(s), for example, a beam portion between two rungs of the ladder. The quick disconnect mechanism 202 is then connected to the ladder holding mechanism 203 to retain the loop(s) around the beam. In other words, the person wraps the ladder tether 201 around the ladder beam(s) and then connects the quick disconnect mechanism 202 to the ladder holding mechanism 203 so that the ladder tether 201 does not unwrap or unloop from the ladder beam. In wrapping or looping the ladder tether 201 the person may make multiple loops or wraps around the ladder beam, for example, by going around the beam multiple times. To offer more stability, the user may choose to use two ladder stabilization devices, one on each beam of the ladder. In this case, the user may perform the same steps for both stabilization devices on each beam of the ladder.

At 102 an object connector portion of the ladder stabilization device 200 may be attached to a portion of an object. The portion of the object may be proximate to the beam of the ladder where the ladder connector portion has been attached. It should be understood that the attachment of the object connector portion and the attachment of the ladder connector portion may happen in any order. In other words, although the attachment of the ladder connector portion is described as occurring before the attachment of the object connector portion, the attachment of the object connector portion may actually occur before the attachment of the ladder connector portion.

The object connector portion may include an object tether portion 204 and an object quick disconnect mechanism 205. The object tether portion 204 and the object quick disconnect mechanism 205 may be any of the materials or mechanisms as described in connection with the ladder tether portion 201 and the ladder quick disconnect mechanism 202. The tether portions 201 and 204 may be the same materials across the ladder stabilization device 200. On the other hand, the object tether portion 204 may be made of a different material than the ladder tether portion 201. In other words, the materials for the two tethers do not have to be consistent across the ladder stabilization device 200. For example, the ladder tether portion 201 may be paracord, with the object tether portion 204 may be braided webbing. One reason that the materials may be different is to allow for different mechanisms for removing slack from the ladder stabilization device 200, as explained in more detail below. For example, the adjustment mechanism may require or necessitate a particular type of material to allow for adjustment.

Similarly, while the quick disconnect mechanisms 202 and 205 may be the same, the object quick disconnect mechanism 205 may be a different mechanism than the ladder quick disconnect mechanism 202. For example, the ladder quick disconnect mechanism 202 may be a buckle while the object quick disconnect mechanism 205 is a carabiner. One reason that the quick disconnect mechanisms 202 and 205 may be different is so that a user can quickly identify which mechanisms or components should be connected together. For example, if the ladder quick disconnect component 202 is a portion of a buckle, the ladder holding mechanism 203 is the other portion of the buckle, and the object quick disconnect mechanism 205 is a carabiner, the user could easily identify that the ladder quick disconnect mechanism 202 should be connected to the ladder holding mechanism 203. Another reason that the quick disconnect mechanisms 202 and 205 may be different mechanisms is to allow for attachment to different objects. For example, if the object to be attached to has a hook, the object quick disconnect mechanism 205 may be a mechanism that allows to connection of that hook portion of the object.

As with the ladder tether 201, ladder quick disconnect mechanism 202, and ladder holding mechanism 203, the object tether 204, object quick disconnect mechanism 205, and object holding mechanism 206, if applicable, may be located in different configurations and/or locations than that shown in FIG. 2, where the object quick disconnect mechanism 205 is located as substantially an end of the object tether 204. Additionally, the object quick disconnect mechanism 205 and object holding mechanism 206, if applicable, may be attached to the object tether 204 using a variety of attachment techniques, for example, those discussed in connection with the ladder connector portion.

In attaching to the object or a portion of the object (e.g., a branch of a tree, a gutter hanger of a house, an object attachment mechanism, etc.), the user may secure the object tether 204 to the portion of the object using the object quick disconnect mechanism 205. In one embodiment, this attachment may be performed similarly to the attachment of the ladder connector portion. In this case, the object connector portion may include an object holding mechanism 206. The user would then wrap or loop the object tether 204 around a portion of the object and then connect the object quick disconnect mechanism 205 to the object holding mechanism 206. The looping or wrapping may also be completed even if the object connector portion does not include an object holding mechanism 206. For example, the object quick disconnect mechanism 205 may be connected to the object tether 204 itself, or may be connected to the ladder holding mechanism 203. In the latter case, the ladder holding mechanism 203 may be large enough or of a type that would allow for connection of both the ladder quick disconnect mechanism 202 and the object quick disconnect mechanism 205.

Attachment of the object connector portion may also include not making a loop and instead connecting the object quick disconnect mechanism 205 directly to the portion of the object. For example, the ladder stabilization system may include one or more object attachment mechanisms 220. The object attachment mechanism 220 may include a mechanism that is attached directly to the object. For example, as illustrated in FIG. 2, the object attachment mechanism 220 includes a D-ring with a plate having a hole in the plate. Using this example, the object attachment mechanism 220 would be installed on the object, for example, using screws, nails, bolts, spikes, or any other coupling mechanism, and the object quick disconnect mechanism 205 would connect directly to the D-ring. Such an embodiment may be practical in the case of a house or other structure where the object attachment mechanism 220 could be installed on the roof or other portion of the structure. Additionally, the object attachment mechanism 220 may be useful in situations where the object does not have another portion that can be easily accessed or attached to using other techniques. The object attachment mechanism 220 may also be used to create the loop as discussed above. Thus, in the use case of an object attachment mechanism 220, the object attachment mechanism 220 would act as the portion of the object for attachment of the object connector portion.

Once the ladder connector portion and the object connector portion are attached, it may be determined if there is any slack between the ladder the connector portion and the object connector portion at 103. Identifying slack may be variable. In other words, some slack between the two connector portions may be okay or not okay depending on the application. In the case that there is no slack or an acceptable amount of slack, the ladder may be considered stabilized at 105 and ready for use. The ladder may be also be considered stabilized and ready for use at 105 when the slack has been removed, as described in more detail below.

In the case that there is an unacceptable amount of slack, the length of the ladder stabilization device 200 may be adjusted at 104. To adjust the length of the ladder stabilization device 200, the ladder stabilization device 200 may include an adjustment mechanism 207. The adjustment mechanism 207 may be located between the ladder connector portion and the object connector portion and may also connect the two portions. The adjustment mechanism 207 may be any of a variety of adjustment mechanisms, for example, a rope adjuster, pulley, ring, or the like. The selected adjustment mechanism may include a locking adjustment mechanism where when a portion (e.g., the ladder tether 201, the object tether 204, etc.) is pulled through the adjustment mechanism 207, that portion will not pull back out without manipulating a component of the adjustment mechanism 207 to release the portion. On the other hand, the adjustment mechanism 207 may be a simple component that allows for pulling of a portion and then the pulled through portion is secured so that it cannot back through the adjustment mechanism 207.

The illustration of FIG. 2 illustrates that the ladder tether 201 is on the adjustable side of the adjustment mechanism 207, meaning that the ladder tether 201 is the portion that is pulled through the adjustment mechanism 207. However, this is merely an example, and it may be that the object tether 204 is the portion that is pulled through the adjustment mechanism 207. In the illustration of FIG. 2, the ladder tether 201 loops through the adjustment mechanism 207. Thus, the ladder tether 201 may include a portion where two lengths of ladder tether 201 are next to each other so that one can be pulled through the adjustment mechanism 207, thereby shortening or lengthening the ladder stabilization device 200.

The ladder stabilization system may include other components, for example, a storage pouch 240 for storing the ladder stabilization device(s) 200 and/or other components. The system may also include a user's manual, material specifications, device specifications, and the like.

Thus, the described systems and methods provide a system that allows for quick stabilization of a ladder with respect to an object. Since the components of the ladder stabilization device are designed to allow quick setup and take down of the ladder stabilization device, the device may be deployed quickly, thereby encouraging the use of the device. Additionally, when in use, the ladder stabilization device provides a mechanism for decreasing the likelihood that the ladder will fall from a desired position, thereby decreasing ladder related injuries, damage to objects, and emergency calls due to people being stranded at a higher elevation with no safe, controlled way to descend to a lower elevation due to the fact that the ladder fell.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for stabilizing a ladder with respect to an object, comprising:
attaching a ladder connector portion of a ladder stabilization device to a beam of a ladder, the beam being a portion of the ladder proximate to a location of an object;
the attaching a ladder connector portion comprising wrapping a ladder tether portion of the ladder connector portion around the beam of the ladder to create at least one loop around the beam and connecting a ladder quick disconnect mechanism located at substantially the end of the ladder tether portion to a ladder holding mechanism located within the ladder connector portion to retain the at least one loop of the ladder tether portion around the beam;
attaching an object connector portion of the ladder stabilization device to a portion of the object, the portion of the object being proximate to the beam of the ladder;
the attaching an object connector portion comprising securing an object tether portion of the object connector portion to the portion of the object using an object quick disconnect mechanism located at substantially the end of the object tether portion; and
adjusting a length of the ladder stabilization device to a length to remove slack of the ladder stabilization device between the beam and the portion of the object using an adjustment mechanism, the adjustment mechanism being located within the ladder stabilization device between the ladder connector portion and the object connector portion.

2. The method of claim 1, further comprising attaching an object attachment mechanism to the object and wherein the object attachment mechanism is the portion of the object.

3. The method of claim 2, wherein the attaching an object connector portion comprises connecting the object quick disconnect mechanism to the object attachment mechanism.

4. The method of claim 1, wherein the attaching an object connector portion comprises wrapping the object tether portion around the portion of the object to create at least one loop around the portion of the object, and connecting the object quick disconnect mechanism to an object holding mechanism located within the object connector portion to retain the at least one loop of the object tether portion around the portion of the object.

5. The method of claim 4, wherein at least one of: the ladder holding mechanism and the object holding mechanism comprises a holding mechanism selected from the group consisting of: a loop, a hook, a ring, a buckle, and a snap.

6. The method of claim 1, wherein the adjustment mechanism comprises an adjuster selected from the group consisting of: a rope adjuster, a pulley, and a ring.

7. The method of claim 1, wherein at least one of: the ladder quick disconnect mechanism and the object quick disconnect mechanism comprises a quick disconnect mechanism selected from the group consisting of: a carabiner, a hook, a snap, a buckle, a shackle, and a clevis.

8. The method of claim 1, wherein at least one of: the ladder tether portion and the object tether portion comprises a tether selected from the group consisting of: paracord, rope, wire, and braided webbing.

9. A system for stabilizing a ladder with respect to an object, comprising:
at least two ladder stabilization devices, each ladder stabilization device comprising:
a ladder connector portion comprising: a ladder tether portion, a ladder quick disconnect mechanism located at substantially the end of the ladder tether portion, and a ladder holding mechanism for connection of the ladder quick disconnect mechanism;
wherein, when in use, the ladder tether portion is wrapped around a beam of a ladder to create at least one loop around the beam, the beam being proximate to an object, and the ladder quick disconnect mechanism is connected to the ladder holding mechanism to retain the at least one loop of the ladder tether portion around the beam;
an object connector portion comprising: an object tether portion and an object quick disconnect mechanism located at substantially the end of the object tether portion;
wherein, when in use, the object quick disconnect mechanism is used to secure the object tether portion to a portion of the object, the portion of the object being proximate to the beam of the ladder; and
an adjustment mechanism located between the ladder connector portion and the object connector portion, wherein the adjustment mechanism comprises a mechanism for adjusting a length of at least one of: the ladder tether portion and the object tether portion.

10. The system of claim 9, wherein the object connector portion comprises an object holding mechanism for connection of the object quick disconnect mechanism.

11. The system of claim 10, wherein to secure the object tether portion comprises wrapping the object tether portion around a portion of the object to create at least one loop around the portion of the object, and the object quick disconnect mechanism is connected to the object holding mechanism to retain the at least one loop of the object tether portion around the portion of the object.

12. The system of claim 10, wherein at least one of: the ladder holding mechanism and the object holding mechanism comprises a holding mechanism selected from the group consisting of: a loop, a hook, a ring, a buckle, and a snap.

13. The system of claim 9, further comprising an object attachment mechanism that is attached to the object, the object attachment mechanism, when installed, being the portion of the object.

14. The system of claim 13, wherein the object quick disconnect mechanism is connected to the object attachment mechanism when in use.

15. The system of claim 9, further comprising a storage pouch for the ladder stabilization device.

16. The system of claim 9, wherein the adjustment mechanism comprises an adjuster selected from the group consisting of: a rope adjuster, a pulley, and a ring.

17. The system of claim 9, wherein at least one of: the ladder quick disconnect mechanism and the object quick disconnect mechanism comprises a quick disconnect mechanism selected from the group consisting of: a carabiner, a hook, a snap, a buckle, a shackle, and a clevis.

18. The system of claim 9, wherein at least one of: the ladder tether portion and the object tether portion comprises a tether selected from the group consisting of: paracord, rope, wire, and braided webbing.

19. A system for stabilizing a ladder with respect to an object, comprising:
two ladder stabilization devices, each ladder stabilization device comprising:
a ladder connector portion comprising: a ladder tether portion comprising paracord, a ladder quick disconnect mechanism comprising a carabiner and located at the end of the ladder tether portion, and a ladder holding mechanism comprising a ring for connection of the ladder quick disconnect mechanism;
wherein, when in use, the ladder tether portion is wrapped around a beam of a ladder to create at least one loop around the beam, the beam being proximate to an object, and the ladder quick disconnect mechanism is connected to the ladder holding mechanism to retain the at least one loop of the ladder tether portion around the beam;
an object connector portion comprising: an object tether portion comprising braided webbing, an object quick disconnect mechanism comprising a carabiner and located at the end of the object tether portion;
wherein, when in use, the object tether portion is wrapped around a portion of the object to create at least one loop around the portion of the object, the portion of the object being proximate to the beam of the ladder, and the quick disconnect mechanism is connected to an object holding mechanism comprising a ring to retain the at least one loop of the object tether portion around the portion of the object; and
an adjustment mechanism located between the ladder connector portion and the object connector portion, wherein the adjustment mechanism comprises a rope adjustment mechanism for adjusting a length of at least one of: the ladder tether portion and the object tether portion to remove slack of the ladder stabilization device between the beam and the portion of the object.

20. The system of claim 19, further comprising a storage pouch for the ladder stabilization device.
